(19) United States
(12) Patent Application Publication
(10) Pub. No.: US 2010/0333128 A1
(43) Pub. Date: Dec. 30, 2010

(54) Control and Monitoring of Content by Access Devices

(75) Inventors: Michael Lawrence Smith, Canton, GA (US); Francisco Gonzalez, Atlanta, GA (US)

Correspondence Address: Merchant & Gould - Cox, PO Box 2903, Minneapolis, MN, 55402, US

(73) Assignee: Cox Communications, Inc., Atlanta, GA (US)

(21) Appl. No.: 12/692,687

(22) Filed: Jan. 25, 2010

Related U.S. Application Data
(60) Provisional application No. 61/220,966, filed on Jun. 26, 2009.

(51) Int. Cl. H04N 7/16; G06F 21/00

(52) U.S. Cl. 725/25; 726/4

(57) ABSTRACT

A device for controlling access to content. The device includes memory for storing data, a processor, coupled to the memory, for authorizing a user and presenting to the authorized user identification of access devices and information regarding the content being accessed by the access devices and a communications interface, coupled to the processor, for enabling data exchange between the processor and the access devices in the network. The processor is configured to initiate a selected control function of a chosen access device upon receiving a command from the authorized user based on the identification of the chosen access device and the information regarding the content being accessed by the chosen access device.

### RELATED APPLICATION

Under provisions of 35 U.S.C. §119(e), the Applicants claim the benefit of U.S. provisional application No. 61/220,966, filed Jun. 26, 2009, which is incorporated herein by reference.

### FIELD OF THE INVENTION

This disclosure relates in general to providing monitoring of content, and more particularly to providing authorized control and monitoring of content provisioning at multiple locations over a network.

### BACKGROUND

Broadband communications systems, such as satellite and cable television systems, are now capable of providing many services in addition to analog broadcast video. In implementing enhanced programming, the set-top terminal (STT), otherwise known as the set-top box (STB), has become an important computing device for accessing various video services. In addition to supporting traditional analog broadcast video functionality, many STTs now also provide other functionality, such as, for example, an interactive program guide (IPG), picture-in-picture (PIP) viewing, video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, play back that recorded video as desired by the user, and transfer the video to an archival or removable storage device possibly using a DVD recorder. This functionality has become known as a “digital video recorder” (DVR) or personal video recorder (PVR) and is viewed as a superior alternative to conventional video tape recorders for capture and subsequent playback of programming content.

A STT is typically connected to a television set and located at the home of the cable or satellite system subscriber. Since the STT is located at a subscriber's premises, it typically may be used by two or more users (e.g., household members). Television has become so prevalent in the United States that the typical household may have two or more television sets, each television set requiring its own STT if the subscriber wishes to have access to enhanced functionality.

A networked multimedia system (NMS) allows a plurality of remote devices in the premises to be locally networked (i.e., home-networked). One of the remote devices typically acts as the server or primary device (i.e., the primary set-top terminal (STT) or set-top-box (STB)) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary device resident presentations, such as a stored or recorded presentation, the interactive program guide, or the network guide, for example.

STTs typically operate a set of features that affect the viewer experience. Some typical features include parental control settings that enable a customer (also referred herein as “supervisor”) to restrict the content that may be viewed at a customer location. Often, a customer may have several STTs, each controlling a separate television. Moreover, multiple users may be are operating discrete STTs within a networked premises to access programming and content received by and/or stored in another STT. Each STT typically has a separate identifier and may be controlled by a separate personal identifier number (PIN).

However, the content available over the television networks includes a wide variety subject matter, such as content categorized not suitable for certain age groups, VoD, pay-per-view, sexually explicit content, etc. Customers may desire to control the viewing and recording of some of such content delivered to the customer devices, such as the STTs. In particular, parents are deeply concerned with the ways their children choose to spend their time. Many parents feel they are failing in the task of protecting their children from violent or sexually explicit content, in TV shows, videos, DVDs, songs, computer games, and in material downloaded from the Internet. A closely related concern is the large number of hours children spend absorbing electronic entertainment instead of engaging in more mentally or physically stimulating activities, such as reading, playing, or engaging in sports.

Furthermore, parents do not currently have any convenient way of tracking the overall patters of entertainment consumption of their children. For example, a child may be wasting 20 hours a week watching TV, watching DVDs, playing computer games, and listening to obscene rap lyrics, without the parents being aware of the total amount of time involved. Accordingly, the need remains for a way to allow parents to monitor and control the viewing of content via STTs.

### SUMMARY OF THE INVENTION

To overcome the limitations described above, and to overcome other limitations that will become apparent upon reading and understanding the present specification, embodiments for providing control and monitoring of content provisioning at multiple locations over a network are disclosed.

An embodiment includes device for controlling access to content. The device includes memory for storing data, a processor, coupled to the memory, for authorizing a user and presenting to the authorized user identification of access devices and information regarding the content being accessed by the access devices and a communications interface, coupled to the processor, for enabling data exchange between the processor and the access devices in the network, wherein the processor is configured to initiate a selected control function of a chosen access device upon receiving a command from the authorized user based on the identification of the chosen access device and the information regarding the content being accessed by the chosen access device.

In another embodiment, a method for controlling access to content is provided. The method includes authorizing a user for an access control device, presenting to the authorized user identification of access devices and information regarding the content being accessed by the access devices, exchanging data between the processor and the access devices in the network, receiving a command from the authorized user based on identification of a chosen access device and information regarding the content being accessed by the chosen access device, and initiating a selected control function of the chosen access device upon receiving the command from the authorized user.

In another embodiment, a computer readable medium including executable instructions which, when executed by a processor, controls access to content is provided. Access to content is controlled by authorizing a user for an access control device, presenting to the authorized user identification of access devices and information regarding the content being accessed by the access devices, exchanging data between the processor and the access devices in the network, receiving a command from the authorized user based on identification of a chosen access device and information regarding the content being accessed by the chosen access device, and initiating a selected control function of the chosen access device upon receiving the command from the authorized user.

These and various other advantages and features of novelty are pointed out with particularity in the claims annexed hereto and form a part hereof. However, for a better understanding of the disclosed embodiments, the advantages, and the objects obtained, reference should be made to the drawings which form a further part hereof, and to accompanying descriptive matter, in which there are illustrated and described specific examples of the disclosed embodiments.

### BRIEF DESCRIPTION OF THE DRAWINGS

Referring now to the drawings in which like reference numbers represent corresponding parts throughout:

FIG. 1 is a diagram of a system for providing digital and analog video programming, information content, and interactive television services according to an embodiment of the invention;

FIG. 2 is a diagram of a home having set-top boxes and a control monitoring device according to an embodiment of the invention;

FIG. 3 is a control interface according to an embodiment of the invention;

FIG. 4 is a block diagram of a monitoring device according to an embodiment of the invention; and

FIG. 5 illustrates a method for providing access controls according to an embodiment of the invention.

### DETAILED DESCRIPTION

Embodiments of the present invention are directed to providing control and monitoring of content provisioning at multiple locations over a network.

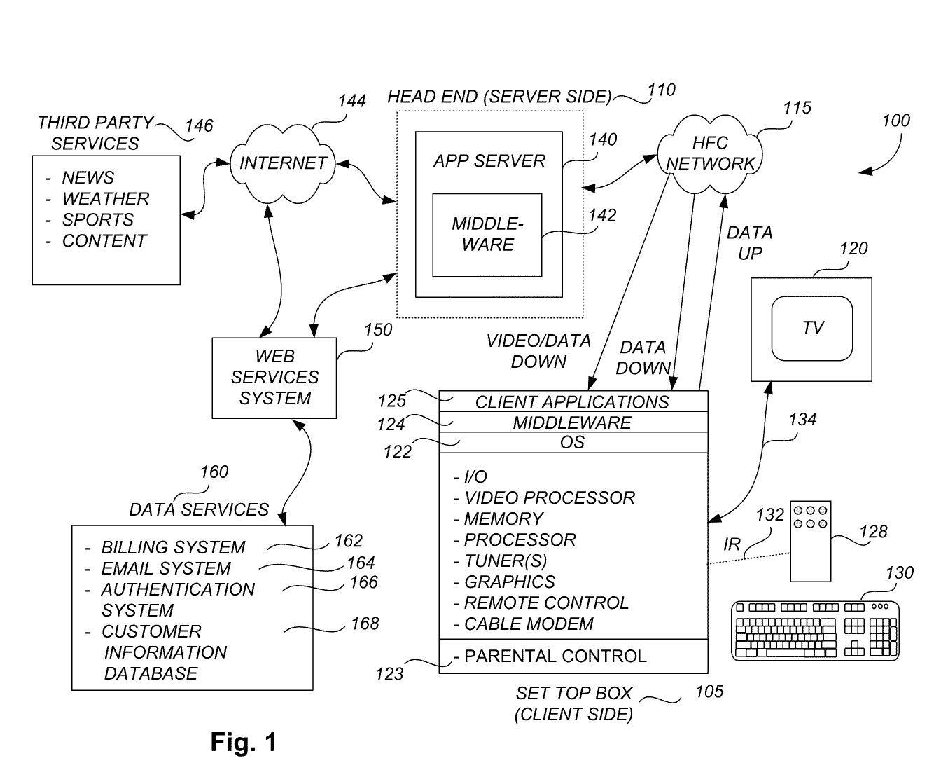

Embodiments of the present invention may be implemented in a number of distributed computing environments where functionality is tailored for provision of customer support services. According to an actual embodiment, the present invention is implemented in a cable television/services system. FIG. 1 is a simplified block diagram illustrating a cable television/services system 100 (hereafter referred to as “CATV”) architecture that serves as an exemplary operating environment for the present invention.

Referring now to FIG. 1, digital and analog video programming, information content, and interactive television services are provided via a hybrid fiber coax (HFC) network 115 to a television set 120 for consumption by a cable television/services system customer. As is known to those skilled in the art, HFC networks 115 combine both optical fiber and coaxial cable lines. Typically, optical fiber runs from the cable head end 110 to neighborhoods of 500 to 2,000 customers. Coaxial cable runs from the optical fiber feeders to each customer. According to embodiments of the present invention, the functionality of the HFC network 115 allows for efficient bidirectional data flow between the client-side set-top box 105 and the server-side application server 140 of the present invention.

According to embodiments of the present invention, the CATV system 100 is in the form of a distributed client-server computing system for providing video and data flow across the HFC network 115 between server-side services providers (e.g., cable television/services providers) via a server-side head end 110 and a client-side customer via a client-side set-top box (STB) 105 functionally connected to a customer receiving device, such as the television set 120. As is understood by those skilled in the art, modem CATV systems 100 may provide a variety of services across the HFC network 115 including traditional digital and analog video programming, telephone services, high speed Internet access, video-on-demand, and information services.

On the client side of the CATV system 100, digital and analog video programming and digital and analog data are provided to the customer television set 120 via the set-top box (STB) 105. Interactive television services that allow a customer to input data to the CATV system 100 likewise are provided by the STB 105. As illustrated in FIG. 1, the STB 105 is a multipurpose computing device having a computer processor, memory and an input/output mechanism. The input/output mechanism receives input from server-side processes via the HFC network 115 and from customers via input devices such as the remote control device 128 and the keyboard 130. The remote control device 128 and the keyboard 130 may communicate with the STB 105 via a suitable communication transport such as the infrared connection 132. The STB 105 also includes a video processor for processing and providing digital and analog video signaling to the television set 120 via a cable communication transport 134. A multi-channel tuner is provided for processing video and data to and from the STB 105 and the server-side head end system 110, described below.

The STB 105 also includes an operating system 122 for directing the functions of the STB 105 in conjunction with a variety of client applications 126. For example, if a client application 125 requires a news flash from a third-party news source to be displayed on the television 120, the operating system 122 may cause the graphics functionality and video processor of the STB 105, for example, to output the news flash to the television 120 at the direction of the client application 126 responsible for displaying news items.

According to an embodiment, the STB 105 may also be configured to implement a parental control application 123. Parental control 123 allows an authorized user to view and control access to what is currently being watched or recorded on any device in a home networked environment. The access control 123 may be configured to allow the authorized user to terminate particular content viewing at another device. Access control 123 may also allow additional control parameters to be implemented at another device, such as recording of a program on a DVR located in an area of the home remote from STB 105, download content from a remote storage device coupled to the STB 105, etc.

Because a variety of different operating systems 122 may be utilized by a variety of different brands and types of set-top boxes, a middleware layer 124 is provided to allow a given software application to be executed by a variety of different operating systems. According to an embodiment of the present invention, the middleware layer 124 may include a set of application programming interfaces (API) that are exposed to client applications 126 and operating systems 122 that allow the client applications to communicate with the operating systems through common data calls understood via the API set. As described below, a corresponding middleware layer is included on the server side of the CATV system 100 for facilitating communication between the server-side application server and the client-side STB 105. According to one embodiment of the present invention, the middleware layer 142 of the server-side application server and the middleware layer 124 of the client-side STB 105 format data passed between the client side and server side according to the Extensible Markup Language (XML).

The set-top box 105 passes digital and analog video and data signaling to the television 120 via a one-way communication transport 134. The STB 105 may receive video and data from the server side of the CATV system 100 via the HFC network 115 through a video/data downlink and data via a data downlink. The STB 105 may transmit data from the client side of the CATV system 100 to the server side of the CATV system 100 via the HFC network 115 via one data uplink. The video/data downlink is an “in band” downlink that allows for digital and analog video and data signaling from the server side of the CATV system 100 through the HFC network 115 to the set-top box 105 for use by the STB 105 and for distribution to the television set 120. As is understood by those skilled in the art, the “in band” signaling space operates at a frequency between 54 and 860 megahertz. The signaling space between 54 and 860 megahertz is generally divided into 6 megahertz channels in which may be transmitted a single analog signal or a greater number (e.g., up to ten) digital signals.

The data downlink and the data uplink, illustrated in FIG. 1, between the HFC network 115 and the set-top box 105 comprise “out of band” data links. As is understand by those skilled in the art, the “out of band” frequency range generally lies between zero and 54 megahertz. According to embodiments of the present invention, data flow between the client-side set-top box 105 and the server-side application server 140 is typically passed through the “out of band” data links. Alternatively, an “in band” data carousel may be positioned in an “in band” channel into which a data feed may be processed from the server-side application server 140 through the HFC network 115 to the client-side STB 105. Operation of data transport between components of the CATV system 100, described with reference to FIG. 1, is well known to those skilled in the art.

Referring still to FIG. 1, the head end 110 of the CATV system 100 is positioned on the server side of the CATV system and includes hardware and software systems responsible for originating and managing content for distributing through the HFC network 115 to client-side STBs 105 for presentation to customers via televisions 120. As described above, a number of services may be provided by the CATV system 100, including digital and analog video programming, interactive television services, telephone services, video-on-demand services, targeted advertising, and provision of information content.

The application server 140 is a general-purpose computing system operative to assemble and manage data sent to and received from the client-side set-top box 105 via the HFC network 115. As described above with reference to the set-top box 105, the application server 140 includes a middleware layer 142 for processing and preparing data from the head end of the CATV system 100 for receipt and use by the client-side set-top box 105. For example, the application server 140 via the middleware layer 142 may obtain data from third-party services 146 via the Internet 140 for transmitting to a customer through the HFC network 115 and the set-top box 105. For example, a weather report from a third-party weather service may be downloaded by the application server via the Internet 144. When the application server 140 receives the downloaded weather report, the middleware layer 142 may be utilized to format the weather report for receipt and use by the set-top box 105.

According to one embodiment of the present invention, data obtained and managed by the middleware layer 142 of the application server 140 may be formatted according to the Extensible Markup Language and passed to the set-top box 105 through the HFC network 115 where the XML-formatted data may be utilized by a client application 126 in concert with the middleware layer 124, as described above. As should be appreciated by those skilled in the art, a variety of third-party services data, including news data, weather data, sports data and other information content may be obtained by the application server 140 via distributed computing environments such as the Internet 144 for provision to customers via the HFC network 115 and the set-top box 105.

According to embodiments of the present invention, the application server 140 may obtain customer support services data, including billing data, information on customer work order status, answers to frequently asked questions, services provider contact information, and the like from data services 160 for provision to the customer via an interactive television session. As illustrated in FIG. 1, the services provider data services 160 include a number of services operated by the services provider of the CATV system 100 which may include data on a given customer.

A billing system 162 may include information such as a customer's name, street address, business identification number, Social Security number, credit history, and information regarding services and products subscribed to by the customer. According to embodiments of the present invention, the billing system 162 may also include billing data for services and products subscribed to by the customer for bill processing billing presentment and payment receipt.

A customer information database 168 may include general information about customers such as place of employment, business address, business telephone number and demographic information such as age, gender, educational level, and the like. The customer information database 168 may also include information on pending work orders for services or products ordered by the customer. The customer information database 168 may also include general customer information such as answers to frequently asked customer questions and contact information for various service provider offices/departments. As should be understood, this information may be stored in a variety of disparate databases operated by the cable services provider.

An electronic mail system 164 may contain information such as electronic mail addresses, high-speed Internet access subscription information and electronic mail usage data. An authentication system 166 may include information such as secure user names and passwords utilized by customers for access to network services. As should be understood by those skilled in the art, the disparate data services systems 162, 164, 166, 168 are illustrated as a collection of data services for purposes of example only. The example data services systems comprising the data services 160 may operate as separate data services systems, which communicate with a web services system (described below) along a number of different communication paths and according to a number of different communication protocols.

Referring still to FIG. 1, a web services system 150 is illustrated between the application server 140 and the data services 160. According to embodiments of the present invention, the web services system 150 serves as a collection point for data requested from each of the disparate data services systems comprising the data services 160. According to embodiments of the present invention, when the application server 140 requires customer services data from one or more of the data services 160, the application server 140 passes a data query to the web services system 150. The web services system formulates a data query to each of the available data services systems for obtaining any required data for a requesting customer as identified by a set-top box identification associated with the customer. The web services system 150 serves as an abstraction layer between the various data services systems and the application server 140. That is, the application server 140 is not required to communicate with the disparate data services systems, nor is the application server 140 required to understand the data structures or data types utilized by the disparate data services systems. The web services system 150 is operative to communicate with each of the disparate data services systems for obtaining necessary customer data. The customer data obtained by the web services system is assembled and is returned to the application server 140 for ultimate processing via the middleware layer 142, as described above.

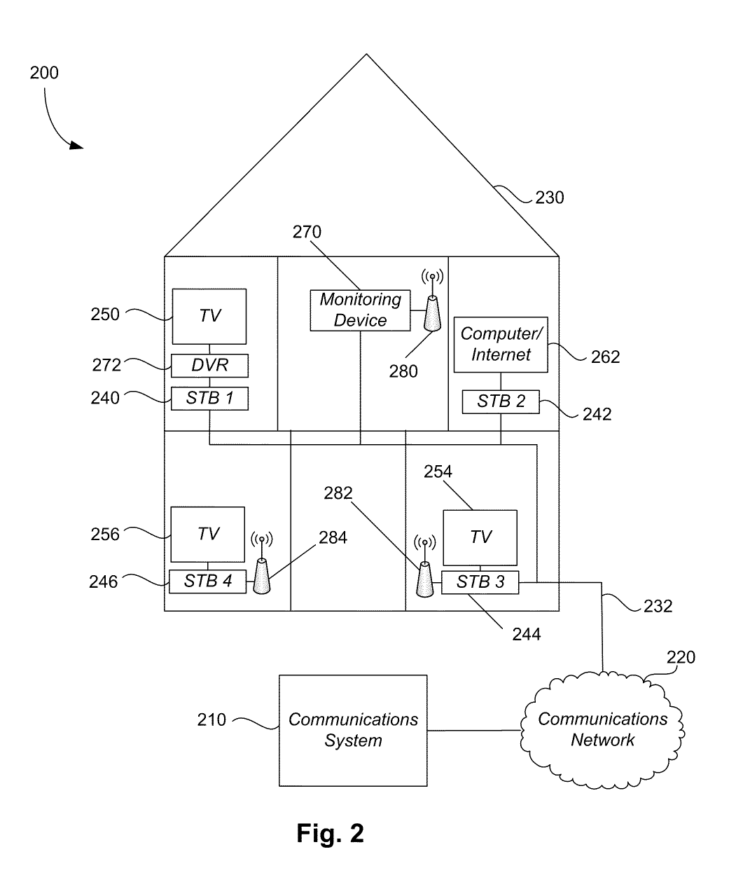

FIG. 2 is a diagram 200 of a home having set-top boxes and a monitoring device according to an embodiment of the invention. In FIG. 2 a communications system 210 provides content to a communications network 220 for deliver to subscribers. One such subscriber may be a single-family residence, an apartment complex, a condominium complex, etc. In FIG. 2, a single-family residence 230 is shown coupled to the communications network 220. Content is provided to the single-family residence 230 via signal path 232. The single-family residence 230 includes 4 set-top boxes (STBs) 240, 242, 244, 246 for processing content signals delivered to the single-family residence 230 via signal path 232. Signal path 232 is coupled to STB 1 240, STB 2 242 and STB 3 244. STB 3 244 is coupled to a wireless device 282. Thus, STB 4 246 may receive content signals from wireless device 282 via wireless device 284. STB 1 240, STB 3 244 and STB 4 246 are coupled to televisions 250, 254, 256, respectively. STB 2 242 is coupled to a computer 262 for accessing the Internet.

Monitoring device 270 may also be coupled to the signal path 232. Monitoring device 270 implements the access controls. Monitoring device 270 may be a master set-top box or may be a dedicated device for providing monitoring functionality. Monitoring device 270 may also be coupled to wireless device 280 to provide communications and control to STB 3 244 and STB 4 246 via wireless devices 282, 284. Monitoring device 270 may also communicate with STB 1 240, STB 2 242 and STB 3 244 via signal path 232. Accordingly, monitoring device 270 may be configured with a parental control application that allows an authorized user to view and control access to what is currently being watched or recorded on any device in a home networked environment, i.e., television 250, television 254, television 256 and computer 262. The parental control application implemented on monitoring device 270 may be configured to allow the authorized user to terminate particular content viewing at such other devices. Monitoring device may also allow additional control parameters to be implemented at another device, such as recording of a program on a DVR 272, download content from a remote storage device, such as DVR 272, etc.

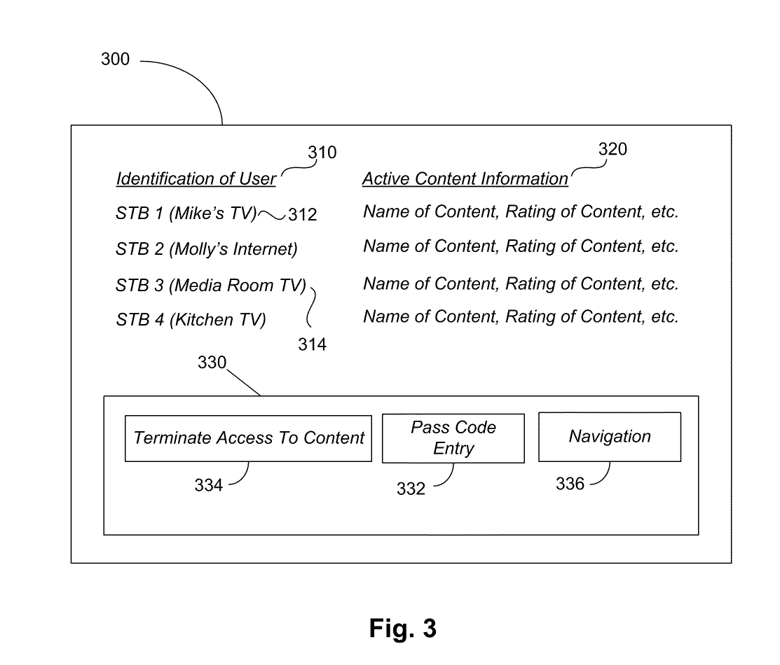

FIG. 3 is a control interface 300 according to an embodiment of the invention. In FIG. 3, the control interface 300 presents to an authorized user information regarding users 310 and active content information 320. The control interface 300 may also be configured to provide a data input and control panel 330. The data input and control panel 330 may be configured to provide a window or dialog box 332 for entering a pass code for authorizing a user. A command button 334 may be presented to trigger termination of access to content. A navigation window 336 may also be provided to allow the user to navigate within the system. For example, the user may highlight a cursor over STB 1 312. The navigation button 336 may then be used to view the content provided to STB 1 312. The command button 334 may be selected to terminate access to the content currently being provided to STB 1 312 if the user desires.

Accordingly, the control interface 300 allows an authorized user to control access to content by other users within the content network. A specific example may include a parent terminating content to STB 1 because the parent considers the content inappropriate, because it is time for Mike to retire for the evening, etc. Those skilled in the art will recognize that additional dialog boxes and/or command buttons may be provided on the control interface 300. For example, a command button may be provided to download content on STB 1 312 for viewing at a different location, e.g., STB 3 314.

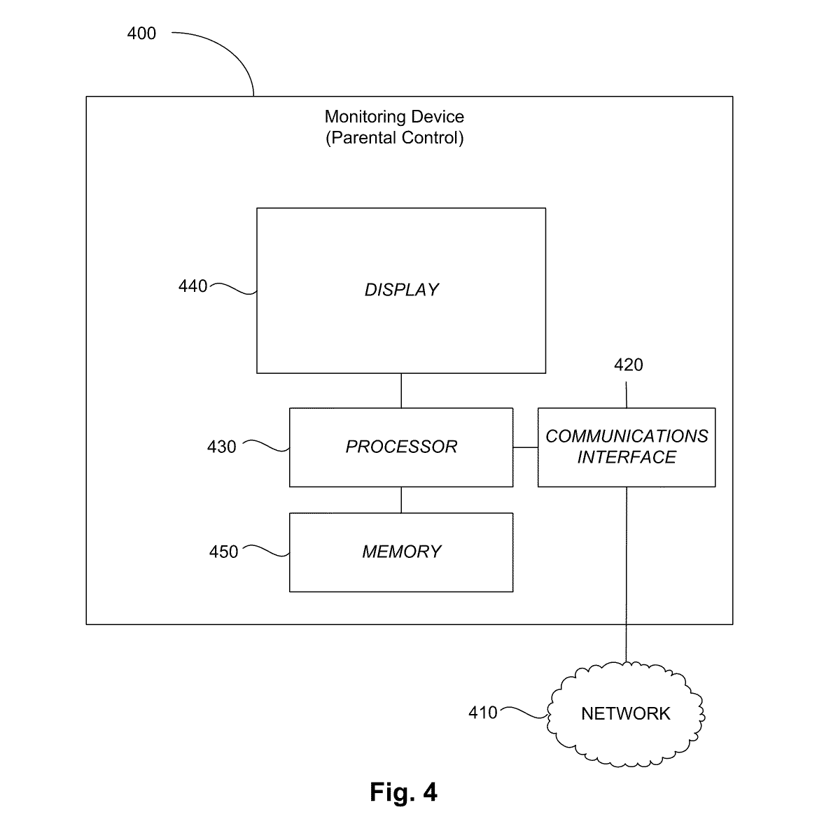

FIG. 4 is a block diagram of a monitoring device 400 according to an embodiment of the invention. In FIG. 4, the monitoring device 400 is coupled to the network 410. As described above, the monitoring device 400 may be coupled to the network 410 by a wireless connections or a wired connection. The monitoring device 400 includes a communications interface 420 for enabling data exchange between the monitoring device 400 and the network 410. A processor 430 is provided for processing data. The processor is coupled to a display 440, memory 450 and communications interface 420. The processor 430 is configured to presents to an authorized user information identifying other devices and active content information. The processor 430 may be configured to present on display 440 a data input and control panel that allows a user to enter a pass code for authorizing a user, a command button for triggering termination of access to content at a particular device within the network and a navigation window for allowing a user to navigate within the system. Those skilled in the art will recognize that the processor 430 may also be configured to provide additional dialog boxes and/or command buttons on a control interface provided on display 440. Memory 450 may store program information for implementing access controls. Memory 450 may also store authorization codes, security programs, device data, viewing logs, etc.

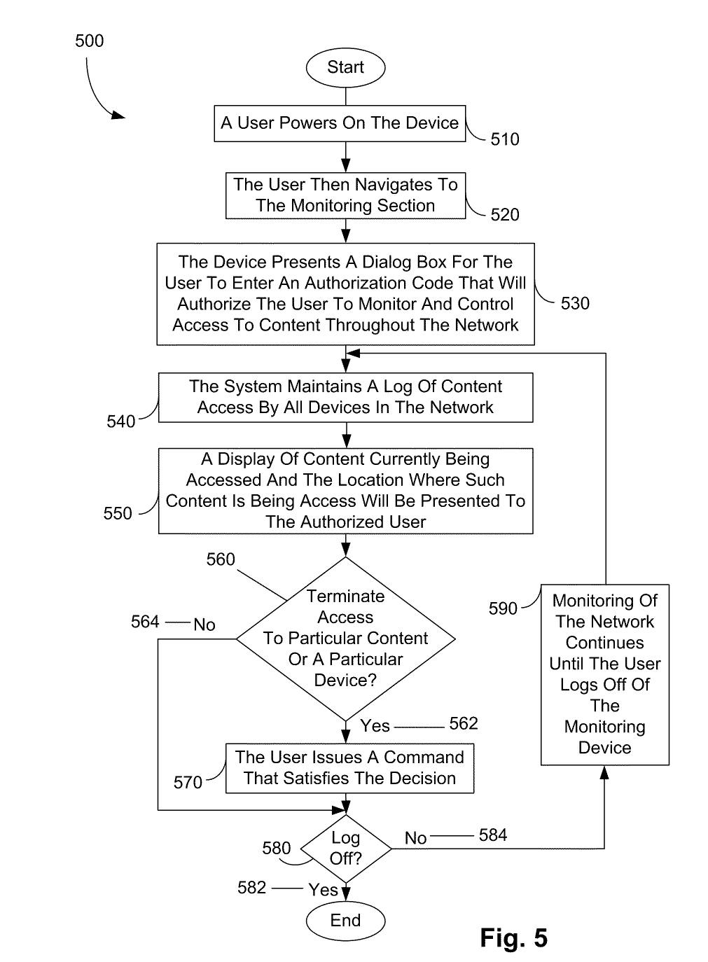

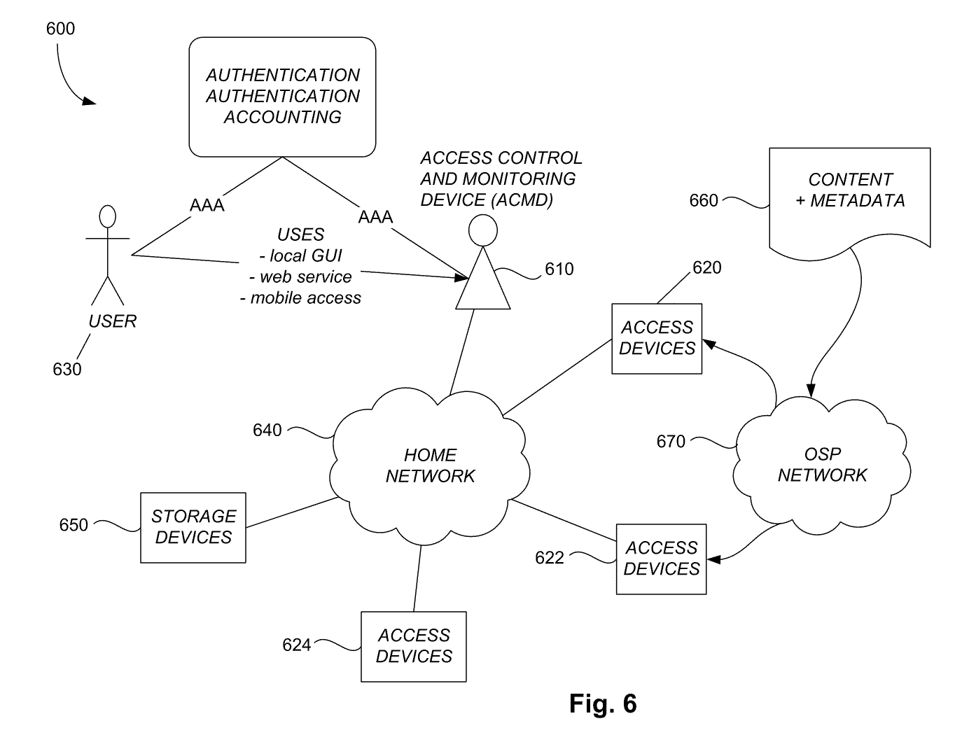

FIG. 5 illustrates a method 500 for providing access controls according to an embodiment of the invention. In FIG. 5, a user powers on the device 510. The user then navigates to the monitoring section 520. The device presents a dialog box for the user to enter an authorization code that will authorize the user to monitor and control access to content throughout the network 530. The system maintains a log of content access by all devices in the network 540. A display of content currently being accessed and the location where such content is being access will be presented to the authorized user 550. A decision may be made whether to terminate access to particular content or by a particular device 560. If the decision is made to terminate access to particular content or by a particular device 562, the user issues a command that satisfies the decision 570. If not 564, a decision is made whether to log off of the device 580. If yes 582, the process ends. If not 584, monitoring of the network continues.

FIG. 6 is a block diagram 600 illustrating an access control and monitoring device (ACMD) according to an embodiment of the invention. In FIG. 6, the ACMD 610 monitors what is being recorded and/or watched by any networked attached device 620-624. The ACMD 610 authenticates and authorizes a user 630 to access content according to predetermined policies. Moreover, the ACMD 610 allows an authenticated and authorized user 630 to set policies to control and manage what others are watching on the network 640. Content may be stored on a network attached storage device 650. The ACMD 610 is aware of content and metadata 660 provided via the Outside Plant (OSP) network 670. The ACMD 610 is also separate from any access device 620-624 and storage device 650.

The ACMD 610 sits on the home network and may be configured as a gateway or part thereof. The ACMD 610 may perform deep packet inspection of home network traffic and can access a list of content from an access device 620-624. The ACMD 610 securely holds user settable policies. However, the ACMD 610 is not reliant on any type of CA or parental control implemented in a STB. The configuration for the ACMD 610 securely persists a database, e.g., user, device, content type, rating, etc.

Thus, control and monitoring of content provisioning is provided at multiple locations over a network. This allows a user to monitor and control the viewing of content via STBs and access devices through the ACMD 610. Control and monitoring of content provisioning may thus be implemented in a number of distributed computing environments where functionality is tailored for provision of customer support services.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A device for controlling access to content, comprising:
memory for storing data;
a processor, coupled to the memory, for authorizing a user and presenting to the authorized user identification of access devices and information regarding the content being accessed by the access devices; and
a communications interface, coupled to the processor, for enabling data exchange between the processor and the access devices in the network;
wherein the processor is configured to initiate a selected control function of a chosen access device upon receiving a command from the authorized user based on the identification of the chosen access device and the information regarding the content being accessed by the chosen access device.

2. The device of claim 1, wherein the selected control function comprises terminating access to content by the chosen access device.

3. The device of claim 1, wherein the selected control function comprises downloading content from the chosen access device.

4. The device of claim 1, wherein the selected control function comprises recording of a program on the chosen access device.

5. The device of claim 1, wherein the access devices are set-top boxes.

6. The device of claim 1, wherein the content comprises one type of content chosen from a group consisting of television programming, movies, sporting events, games, and internet data.

7. The device of claim 1, further comprising a display device for presenting a visual display of access devices and information regarding the content being accessed by the access devices.

8. The device of claim 7, wherein the display device presents a data input interface and a control panel.

9. The device of claim 7, wherein the display device presents a window or dialog box for entering a pass code for authorizing a user.

10. The device of claim 7, wherein the display device presents a command button to trigger termination of access to content by the chosen access device.

11. The device of claim 7, wherein the display device presents a navigation window to allow the user to navigate within the system.

12. The device of claim 7, wherein the display device presents a command button to download content on the chosen access device for viewing at a different location.

13. The device of claim 1, wherein the memory stores authorization codes, security programs, device data and viewing logs.

14. A method for controlling access to content, comprising:
authorizing a user for an access control device;
presenting to the authorized user identification of access devices and information regarding the content being accessed by the access devices;
exchanging data between the processor and the access devices in the network;
receiving a command from the authorized user based on identification of a chosen access device and information regarding the content being accessed by the chosen access device; and
initiating a selected control function of the chosen access device upon receiving the command from the authorized user.

15. The method of claim 14, wherein the authorizing a user further comprises:
navigating to a monitoring section of the access control device; and
presenting a dialog box for the user to enter an authorization code for authorizing the user to monitor and control access to content throughout the network.

16. The method of claim 14, wherein the presenting to the authorized user identification of access devices and information regarding the content being accessed by the access devices further comprises displaying to the authorized user content currently being accessed and the access device associated with accessing the content.

17. The method of claim 14, wherein the initiating a selected control function of the chosen access device further comprises initiating a command to terminate access to the content by the access device associated with the content.

18. The method of claim 14 further comprises maintaining a log of content access by all devices in the network;

19. A computer readable medium including executable instructions which, when executed by a processor, controls access to content by:
authorizing a user for an access control device;
presenting to the authorized user identification of access devices and information regarding the content being accessed by the access devices;
exchanging data between the processor and the access devices in the network;
receiving a command from the authorized user based on identification of a chosen access device and information regarding the content being accessed by the chosen access device; and
initiating a selected control function of the chosen access device upon receiving the command from the authorized user.
